(19) United States
(12) Patent Application Publication
(10) Pub. No.: US 2020/0040126 A1
(43) Pub. Date: Feb. 6, 2020

(54) METHOD FOR CONTROLLED RELEASE OF ANTIMICROBIAL COMPOUNDS

(71) Applicant: Dow Global Technologies LLC, Midland, MI (US)

(72) Inventors: Nicole L. Wagner, Midland, MI (US); Thomas Koehler, Kreuzlingen (CH)

(73) Assignees: Dow Global Technologies LLC, Midland, MI (US); Dow Global Technologies LLC, Midland, MI (US)

(21) Appl. No.: 15/580,916

(22) PCT Filed: Jun. 14, 2016
(86) PCT No.: PCT/US2016/037323

§ 371 Date: Dec. 8, 2017

Related U.S. Application Data
(60) Provisional application No. 62/180,753, filed on Jun. 17, 2015.

(51) Int. Cl. C08G 18/38; C08G 18/79; C09D 175/12

(52) U.S. Cl. CPC C08G 18/3831; C09D 175/12; C08G 18/792

(57) ABSTRACT

A method for delivering antimicrobial compounds to a locus in a controlled manner by adding to the locus a compound having formula (I)

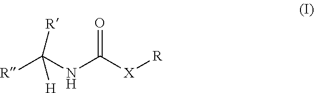

wherein X is O or NH; R is an acrylic polymer, a saturated polyester, an alkyd resin, a polyether or a polycarbonate and R optionally has additional XC(O)NHCHR′R″ substituents; R′ is hydroxyl or NHC(O)XR; and R″ is an organic substituent group having from one to twenty carbon atoms and which optionally has additional CHR′NHC(O)XR substituents.

### BACKGROUND

This invention relates to a method for providing antimicrobial compounds in a controlled manner, especially at high temperatures.

U.S. Pat. No. 8,653,174 discloses polymeric materials made from a polyaldehyde, or an acetal or hemiacetal thereof, and a polycarbamate. However, this reference does not disclose or suggest the method of this invention.

### STATEMENT OF INVENTION

The present invention is directed to a method for delivering antimicrobial compounds to a locus in a controlled manner. The method comprises adding to the locus a compound having formula (I)

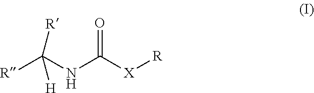

wherein X is O or NH; R is an acrylic polymer, a saturated polyester, an alkyd resin, a polyether or a polycarbonate and R optionally has additional XC(O)NHCHR′R″ substituents; R′ is hydroxyl or NHC(O)XR; and R″ is an organic substituent group having from one to twenty carbon atoms and which optionally has additional CHR′NHC(O)XR substituents.

The present invention is further directed to a method for delivering antimicrobial compounds to a locus in a controlled manner. The method comprises adding to the locus a polymer comprising polymerized units of a polyaldehyde having from two to twenty carbon atoms and polymerized units of a compound having at least two —XC(O)NH₂ groups, wherein X is O or NH.

### DETAILED DESCRIPTION

All temperatures are in ° C. and all percentages are weight percentages (wt %), unless specified otherwise. All reactions are carried out at room temperature (20-25° C.) unless specified otherwise. Weight-average molecular weights are determined using GPC with polystyrene standard. The term “locus” refers to a system or product subject to contamination by microorganisms. The term “(meth)acrylate” means acrylate or methacrylate. An “organic substituent group” is a substituent group having from one to twenty-five non-hydrogen atoms, of which from one to twenty are carbon atoms, and no transition metal atoms. Preferably, organic substituent groups have at least two carbon atoms, preferably at least three, preferably at least four; preferably no more than fifteen carbon atoms, preferably no more than twelve, preferably no more than ten. Preferably organic substituent groups have only carbon, hydrogen, oxygen, nitrogen and phosphorus atoms; preferably carbon, hydrogen and oxygen.

In a preferred embodiment of the invention, R″ is a difunctional substituent which is attached to another CHR′NHC(O)XR moiety, preferably R″ is a C₅-C₂₀ aromatic group, a C₂-C₁₅ difunctional alkyl group or a C₆-C₁₅ difunctional cycloalkyl group; preferably —(CH₂)ₙ—, wherein n is an integer from two to fifteen, preferably two to ten. Preferably, X is O. Preferably, X is N.

Preferably, R′ is NHC(O)XR and the compound has formula (II):

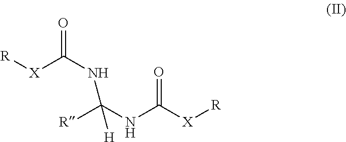

wherein X, R and R″ are as defined previously. Preferably the compound of formula (I) has polymerized units of a polyaldehyde having from two to twenty carbon atoms and a compound having at least two —XC(O)NH₂ groups. Preferably, the aldehyde or polyaldehyde resulting from hydrolysis of the compound of formula (I) or (II) has microbicidal activity. Preferably, the compounds have microbicidal activity against thermophilic microorganisms which can produce sulfide or acids. These microbes can cause corrosion (microbially induced corrosion or MIC), souring and plugging in oil and natural gas filed and other industrial process water systems.

Preferably, the compound of formula (I) is prepared by reacting a compound having at least one —XC(O)NH₂ group with a compound having at least one aldehyde functional group. The reaction may occur in the presence of a catalyst, preferably at temperatures no greater than 110° C., preferably no greater than 90° C., preferably no greater than 70° C., preferably no greater than 50° C.; preferably the temperature is at least 0° C., preferably at least 10° C. A polyaldehyde is a compound having at least two aldehyde groups or acetals or hemiacetals thereof. The term “polyaldehyde” is not used herein to mean a polymeric substance made by self-polymerizing an aldehyde monomer.

Preferably, a compound having at least two —XC(O)NH₂ groups has an average equivalent weight per —XC(O)NH₂ group from 85 to 3,000, preferably from 100 to 1,800. In one preferred embodiment, the compound having at least two —XC(O)NH₂ groups has at least 2.5 —XC(O)NH₂ groups per polymer chain, preferably at least 3, preferably at least 4, preferably at least 5. In one preferred embodiment, the compound having at least two —XC(O)NH₂ groups has no more than 3 —XC(O)NH₂ groups per polymer chain, preferably no more than 2.5, preferably no more than 2.2, preferably no more than 2.1 Preferably, the compound having at least two —XC(O)NH₂ groups is a polycarbamate or a polyurea. As used herein, these terms refer to a polymer having multiple carbamate or urea groups with NH₂ functionality available for reaction, and not a polymer in which carbamate or urea groups are part of the polymer backbone and do not have free NH₂ functionality (e.g., reaction products of polyisocyanates and polyols or polyisocyanates and polyamines).

Preferably, the molecular weight of the polyaldehyde is from 58 to 400, preferably from 58 to 300, preferably from 90 to 200. Preferably, the polyaldehyde has from two to five aldehyde groups, preferably from two to four, preferably two. Preferably, the polyaldehyde has from two to twenty carbon atoms, preferably from two to fifteen, preferably from five to eleven. In one preferred embodiment, the polyaldehyde is chosen from a C₅ to C₁₅ alicyclic or aromatic dialdehyde (e.g., cyclodecanetrialdehyde), preferably, a C₆ to C₁₀ alicyclic or aromatic dialdehyde (e.g., phthalaldehyde, (cis,trans)-1,4-cyclohexanedicarboxyaldehydes, (cis,trans)-1,3-cyclohexanedicarboxyaldehydes and mixtures thereof). Preferably, the polyaldehyde is chosen from a C₂ to C₁₅ aliphatic dialdehyde, preferably C₂ to C₁₀, preferably C₄ to C₈. Especially preferred polyaldehydes include glutaraldehyde, glyoxal, formaldehyde, acetaldehyde, 2-propenal, succinaldehyde, cinnamaldehyde, and o-phthaldehyde; most preferably glutaraldehyde.

Preparation of polycarbamates having carbamate functional groups is described in US2011/0313091. The polycarbamate may be, for example, the condensation product of one or more polyols with an unsubstituted carbamic acid alkyl ester (e.g., methyl carbamate) or urea. Suitable polyols may include, for example, one or more of an acrylic, saturated polyester, alkyd, polyether or polycarbonate polyol. In one preferred embodiment, the polyol has an average functionality of at least 2.5, preferably at least 3, preferably at least 3.5; preferably no more than 7, preferably no more than 5. Preferably, the polycarbamate has a mole ratio of carbamate to hydroxyl groups of at least 1:1, preferably at least 1.2:1, preferably at least 1.4:1. Preferably, a polycarbamate is substantially isocyanate free, i.e., having less than 5 mole percent (mol %) of isocyanate groups based on total moles of carbamate groups plus isocyanate groups in the composition, preferably, less than 3 mol %, preferably, less than 1 mol %, preferably, less than 0.1 mol %. Presence or absence of molecules containing isocyanate groups can be readily determined by Fourier Transform Infrared (FT-IR) spectroscopy or ¹³C-NMR spectroscopy. Where an isocyanate group containing reactant is employed, the polycarbamate prepared therefrom is titrated or “quenched” by an isocyanate quenching agent to convert any residual isocyanate groups to carbamates or amines. Examples of compounds that could be used as an isocyanate quenching agent include, e.g., water, sodium hydroxide, methanol, sodium methoxide, and a polyol. Those skilled in the art will understand how to extend these methods to polymers having urea functional groups.

In a preferred embodiment, the compound is prepared from a mixture of polymers having at least two —XC(O)NH₂ groups. In a preferred embodiment, the compound is prepared from a mixture of polyaldehyde compounds. A mixture of polymers having —XC(O)NH₂ groups may include, for example, a polymer comprising a biodegradable structure and a polymer without a biodegradable structure or with a non-biodegradable structure. Preferably, the polymer having —XC(O)NH₂ groups comprises from 10 to 100 wt % biodegradable structures (based on total weight of biodegradable and non-biodegradable structures in the polymer), preferably at least 25 wt %, preferably at least 40 wt %, preferably at least 50 wt %, preferably at least 60 wt %, preferably at least 70 wt %. Preferably, at least 10 wt % of the biodegradable crosslinked polymer is biodegradable, preferably at least 20 wt %, preferably at least 30 wt %, preferably at least 40 wt %, preferably at least 50 wt %, preferably at least 60 wt %, preferably at least 70 wt %.

The amounts of the compound having at least two —XC(O)NH₂ groups and the polyaldehyde preferably are selected such that the amount of aldehyde functional groups is from 5 to 95 mole % of the amount of —XC(O)NH₂ groups, preferably from 20% to 80%, preferably from 30% to 70%, preferably from 40% to 60%.

The present invention is further directed to a microbicidal composition comprising at least one compound of formula (I). Preferably, the microbicidal composition further comprises other additives such as, but not limited to, surfactants, ionic/nonionic polymers and scale and corrosion inhibitors, oxygen scavengers, nitrate or nitrite salts and/or additional antimicrobial compounds.

In one preferred embodiment, the microbicidal composition is substantially formaldehyde free. Such compositions are substantially free of resins made from formaldehyde, such as aminoplasts and phenol or resole formaldehyde condensates.

Preferably, a catalyst is used to promote the reaction between the —XC(O)NH₂ groups and the aldehyde groups. Examples of catalysts include, e.g., Lewis acids (e.g., boron trifluoride etherate) and protic acids (i.e., Brønsted acids). Preferably, the catalyst comprises a protic acid having a pKa of 6 or lower. Thus, the ambient temperature curable composition of the present invention has a pH of 7.0, or less, preferably, from pH 3 to pH<6. A preferred protic acid is an inorganic protic acid or organic protic acid. A preferred inorganic protic acid is phosphoric acid or sulfuric acid. Preferred organic protic acids include carboxylic acids, phosphonic acids and sulfonic acids. A preferred carboxylic acid is acetic acid, trifluoroacetic acid, propionic acid, or a dicarboxylic acid. A preferred phosphonic acid is methylphosphonic acid. A preferred sulfonic acid is methanesulfonic acid, benzenesulfonic acid, a camphorsulfonic acid; para-toluenesulfonic acid, or dodecylbenzenesulfonic acid.

Examples of suitable Lewis acid curing catalysts are AlCl₃; benzyltriethylammonium chloride (TEBAC); Cu(O₃SCF₃)₂; (CH₃)₂BrS⁺Br⁻; FeCl₃ (e.g., FeCl₃.6H₂O); HBF₄; BF₃.O(CH₂CH₃)₂; TiCl₄; SnCl₄; CrCl₂; NiCl₂; and Pd(OC(O)CH₃)₂.

The catalyst can be unsupported (no solid support) or supported, i.e. covalently bonded to a solid support. Examples of supported catalyst are supported acid catalysts such as acid forms of cation exchange-type polymer resins (e.g., ethanesulfonic acid, 2-[1-[difluoro[(1,2,2-trifluoroethenyl)oxy]methy]]-1,2,2,2-tetrafluoroethoxy]-1,1,2,2-tetrafluoro-, polymer with 1,1,2,2-tetrafluoroethene, sold under trade name NAFION NR 50 (E. I. du Pont de Nemours & Co., Inc.) and ethenylbenzenesulfonic acid polymer with diethenylbenzene sold as AMBERLYST 15 (Rohm and Haas Co.).

Preferably, the catalyst is used in an amount of from 0.001 wt % to 10 wt % of the multicomponent composition, based on the total weight of solids in the composition, more preferably from 0.01 wt % to 5 wt %, preferably from 0.1 wt % to 2 wt %, preferably from 0.3 wt % to 1.5 wt %.

Preferably, the compound or antimicrobial composition in use is exposed to a temperature of at least 35° C., preferably at least 40° C., preferably at least 45° C., preferably at least 50° C., preferably at least 55° C.; preferably no more than 200° C., preferably no more than 150° C., preferably no more than 100° C. Under these conditions the compound releases a microbicidal aldehyde. Preferably, the compound or antimicrobial composition in use is exposed to a relative humidity of at least 50%, preferably at least 55%, preferably at least 60%, preferably at least 65%. In one preferred embodiment the compound or antimicrobial composition is added to a gas field fluid or oil field fluid or fluids for high level disinfection of medical devices. As used herein, the term “fluid” includes but is not limited to gas field fluids or oil field fluids. The phrases “gas field fluid” or “oil field fluid” include stimulation fluid, squeeze fluid, fracturing fluid, drilling mud, workover or completion fluid, water injection or fluid injection for reservoir maintenance or enhanced oil recovery. Hydraulic fracturing fluids or other like compositions. In a preferred embodiment, the gas field fluid or oil field fluid is an aqueous fluid or a fluid that comprises water.

Suitable loci include, for example: industrial process water used in oil or natural gas applications (e.g., drilling fluids, fracturing fluids, water flood systems and oil field water), paper machine white water, industrial recirculating water, starch solutions, latex emulsions, hot rolling machining fluids and industrial dishwashing or laundry fluids. Preferably, the composition is used in oil or natural gas applications.

The specific amount of the composition of this invention necessary to inhibit or control the growth of microorganisms and higher aquatic life forms in a locus depends upon the particular locus to be protected and can easily be determined by a person of ordinary skill in the art. Typically, the amount of the composition of the present invention to control the growth of microorganisms in a locus is sufficient if it contains from 1 to 5,000 ppm polymerized units of polyaldehyde; preferably at least 5 ppm, preferably at least 25 ppm, preferably at least 50 ppm, preferably at least 100 ppm; preferably no more than 3,000 ppm, preferably no more than 2,000 ppm, preferably no more than 1,500 ppm, preferably no more than 1,000 ppm, preferably no more than 500 ppm.

### Examples

### Film Preparation:

The polycarbamate (V370 polycarbamate, 20 g, 0.075 carbamate mol eq) was added to a glass jar and dissolved in 7 g MEK (to prepare ˜60 wt % solution). The solution was warmed at 65 C for 30 min and placed on a horizontal shaker for 1 h to thoroughly mix.

Glutaraldehyde (“glut”) (50 wt % (aq) 7.55 g, 0.075 aldehyde mol eq) was added to the jar and hand shaken to mix well. Then the catalyst, a solution of 25 wt % p-toluenesulfonic acid in isopropanol (1.1 g, 1.0 wt %) was added and the final formulation vigorously shaken by hand for 30 sec. The contents of the jar were poured into a shallow pan and allowed to cure for 7 days. The other polycarbamates in Table 1 were prepared in the same fashion using the weights in the table below.

An example of the preparation of the V370 polycarbamate is below.

1. Add 300 g polyol V370 and 2.95 g of dibutyl tin oxide catalyst to a round-bottom flask.
2. Raise reaction temperature to 155 C (verified by thermocouple reading).
3. Make sure there is something in place to collect the methanol byproduct.
4. Add 148.51 g of methyl carbamate all at once to the round-bottom flask and begin stirring with the mixer.
5. Maintain the reaction temperature at 155 C for about 7 hours.

These seven films were prepared:

| | | | | carbamate: |
|---|---|---|---|---|
| Film | | g | | aldehyde |
| # | polymer | polymer | g glut | mole ratio |
| 1 | V370 polyether¹ carbamate | 20 | 7.68 | 1:1 |
| 2 | PolyG² carbamate (540-378) | 20 | 6.76 | 1:1 |
| 3 | Jeffamine T403³ carbamate | 20 | 7.56 | 1:1 |
| 4 | AU608X⁴ carbamate | 20 | 2.58 | 1:1 |
| 5 | V370 (with more glut 1:2 | 20 | 15.36 | 1:2 |
| | carb:ald mole ratio) | | | |
| 6 | V370 (with less glut | 20 | 3.84 | 2:1 |
| | 2:1 mole ratio) | | | |
| 7 | V370 polyether carbamate | 10 | formaldehyde | 3.11 |
| | | | (37% in | |
| | | | water) | |
| 8 | V370 polyether carbamate | 10 | glyoxal | 2.78 |
| | | | (40 wt % in | |
| | | | water) | |

1. A disaccharide-initiated ethylene oxide (EO)/propylene oxide (PO) polymer having a number average of 6.9 units of EO/PO
2. A pentaerythritol-initiated EO/PO polymer having a number average of 4 units of EO/PO
3. A trimethylolpropane-initiated amine-terminated PO polymer having a number average molecular weight of about 440.
4. A copolymer of 2-hydroxyethyl methacrylate, methyl methacrylate, 2-ethylhexyl acrylate and acrylic acid with 628 eq wt and approximately 30 wt % HEMA

| Film # | polymer | wt % glut¹ |
|---|---|---|
| 1 | V370 polyether carbamate | 7 |
| 2 | PolyG carbamate (540-378) | 6 |
| 3 | Jeffamine T403 carbamate | 6.6 |
| 4 | AU608X carbamate | 2.7 |
| 5 | V370 (with more glut 1:2 carb:ald | 10.5 |
| | mole ratio) | |
| 6 | V370 (with less glut 2:1 mole | 3.8 |
| | ratio) | |

1. Calculated on an anhydrous basis

### Measuring Release of Glutaraldehyde:

Released glutaraldehyde is derivatized with 2,4-dinitrophenylhydrozine under acidic conditions. The derivatives are then separated by reverse-phase HPLC (C-18 column, water/acetonitrile gradient, 60° C.) and detected by UV at a wavelength of 360 nm.

Sample of the films (0.5 g) were immersed in 100 mL of artificial sea water (Ricca Chemical Co.; pH 8.2-8.5, contains NaCl, CaCl₂, KCl, MgCl₂, NaHCO₃ and NaOH) at the temperatures indicated below. Samples of the water were taken periodically and analyzed for glutaraldehyde content. The data in the tables below demonstrate that all films exhibit controlled release. For example, after 3 d at 70 C, 100% of the glut was released from film 1. After 5 d at 70 C, 100% of the glut was released in films 4 and 6. After 14 d at 25 C, 30% of glut was released from film 6, 10% was released from film 1 and 0% was released from film 4.

Film 1
Glut Released (ppm)

| Time (hrs) | 25° C. | 70° C. |
|---|---|---|
| 0 | 0.0 | 0.0 |
| 1 | 0.0 | 714.0 |
| 72 | 311.0 | 29,316.0 |
| 120 | 494.0 | 29,583.0 |
| 168 | 969.0 | 25,504.0 |
| 336 | 2,866.0 | 18,232.0 |

Film 2
Glut Released (ppm)

| Time (hrs) | 25° C. | 70° C. |
|---|---|---|
| 0 | 0.0 | 0.0 |
| 1 | 0.0 | 721.0 |
| 72 | 363.0 | 11,738.0 |
| 120 | 825.0 | 15,455.0 |
| 168 | 1,020.0 | 15,667.0 |
| 336 | 2,131.0 | 15,615.0 |

Film 3
Glut Released (ppm)

| Time (hrs) | 25° C. | 70° C. |
|---|---|---|
| 0 | 0.0 | 0.0 |
| 1 | 0.0 | 415.0 |
| 72 | 0.0 | 3,879.0 |
| 120 | 0.0 | 4,021.0 |
| 168 | 0.0 | 4,038.0 |
| 336 | 0.0 | 4,060.0 |

Film 4
Glut Released (ppm)

| Time (hrs) | 25° C. | 70° C. |
|---|---|---|
| 0 | 0.0 | 0.0 |
| 1 | 0.0 | 329.0 |
| 72 | 0.0 | 6,632.0 |
| 120 | 0.0 | 8,250.0 |
| 168 | 0.0 | 6,836.0 |
| 336 | 0.0 | 6,821.0 |

Film 5
Glut Released (ppm)

| Time (hrs) | 25° C. | 70° C. |
|---|---|---|
| 0 | 0.0 | 0.0 |
| 1 | 0.0 | 2,333.0 |
| 72 | 1,815.0 | 61,536.0 |
| 120 | 4,281.0 | 66,320.0 |
| 168 | 5,048.0 | 66,227.0 |
| 336 | 11,356.0 | 53,809.0 |

Film 6
Glut Released (ppm)

| Time (hrs) | 25° C. | 70° C. |
|---|---|---|
| 0 | 0.0 | 0.0 |
| 1 | 0.0 | 508.0 |
| 72 | 289.0 | 9,575.0 |
| 120 | 798.0 | 11,457.0 |
| 168 | 1,034.0 | 7,000.0 |
| 336 | 3,679.0 | 4,749.0 |

Further experiments were conducted on Films 2, 3 and 4, with the following results:

Film 2

| Glut Conc | | time |
|---|---|---|
| (ug/mL) | Temp | (day) |
| 0 | 25 | 0 |
| 4.2 | 25 | 1 |
| 6.2 | 25 | 2 |
| 8.5 | 25 | 3 |
| 8.6 | 25 | 4 |
| 6.2 | 25 | 7 |
| 6.5 | 25 | 8 |
| 6.7 | 25 | 10 |
| 3.6 | 25 | 16 |
| 3.6 | 25 | 17 |
| 3.3 | 25 | 18 |
| 3.2 | 25 | 21 |
| 2.8 | 25 | 23 |
| 3.0 | 25 | 25 |
| 11.2 | 40 | 1 |
| 13.9 | 40 | 2 |
| 17.1 | 40 | 3 |
| 18.6 | 40 | 4 |
| 13.8 | 40 | 7 |
| 14.1 | 40 | 8 |
| 14.7 | 40 | 10 |
| 15.9 | 40 | 16 |
| 15.5 | 40 | 17 |
| 15.3 | 40 | 18 |
| 15.2 | 40 | 21 |
| 14.8 | 40 | 23 |
| 14.7 | 40 | 25 |
| 48.7 | 70 | 1 |
| 56.6 | 70 | 2 |
| 56.4 | 70 | 3 |
| 53.8 | 70 | 4 |
| 47.1 | 70 | 7 |
| 42.6 | 70 | 8 |
| 36.8 | 70 | 10 |
| 28.6 | 70 | 16 |
| 26.0 | 70 | 17 |
| 22.8 | 70 | 18 |
| 18.2 | 70 | 21 |
| 15.3 | 70 | 23 |
| 12.9 | 70 | 25 |

Film 3

| Glut Conc | | time |
|---|---|---|
| (ug/mL) | Temp | (day) |
| 0 | 25 | 0 |
| 0 | 25 | 1 |
| 0.3 | 25 | 2 |
| 0.4 | 25 | 3 |
| 0.2 | 25 | 4 |
| 0 | 25 | 7 |
| 0.0 | 25 | 8 |
| 0.0 | 25 | 10 |
| 0.0 | 25 | 16 |
| 0.0 | 25 | 17 |
| 0.0 | 25 | 18 |
| 0.0 | 25 | 21 |
| 0.0 | 25 | 23 |
| 0.0 | 25 | 25 |
| 2.3 | 40 | 1 |
| 2.8 | 40 | 2 |
| 3.0 | 40 | 3 |
| 3.2 | 40 | 4 |
| 3.6 | 40 | 7 |
| 3.7 | 40 | 8 |
| 3.6 | 40 | 10 |
| 3.7 | 40 | 16 |
| 3.8 | 40 | 17 |
| 3.6 | 40 | 18 |
| 3.7 | 40 | 21 |
| 3.6 | 40 | 23 |
| 3.3 | 40 | 25 |
| 18.4 | 70 | 1 |
| 16.8 | 70 | 2 |
| 13.7 | 70 | 3 |
| 10.6 | 70 | 4 |
| 4.8 | 70 | 7 |
| 3.9 | 70 | 8 |
| 3.2 | 70 | 10 |
| 2.6 | 70 | 16 |
| 2.5 | 70 | 17 |
| 2.3 | 70 | 18 |
| 2.1 | 70 | 21 |
| 2.2 | 70 | 23 |
| 2.1 | 70 | 25 |

Film 4

| Glut Conc | | time |
|---|---|---|
| (ug/mL) | Temp | (day) |
| 0.0 | 25 | 0 |
| 0.0 | 25 | 1 |
| 0.6 | 25 | 2 |
| 0.9 | 25 | 3 |
| 0.7 | 25 | 4 |
| 0.0 | 25 | 7 |
| 0.0 | 25 | 8 |
| 0.0 | 25 | 10 |
| 0.0 | 25 | 16 |
| 0.0 | 25 | 17 |
| 0.0 | 25 | 18 |
| 0.0 | 25 | 21 |
| 0.0 | 25 | 23 |
| 0.0 | 25 | 25 |
| 3.1 | 40 | 1 |
| 4.9 | 40 | 2 |
| 6.5 | 40 | 3 |
| 7.8 | 40 | 4 |
| 10.7 | 40 | 7 |
| 11.2 | 40 | 8 |
| 12.3 | 40 | 10 |
| 15.5 | 40 | 16 |
| 15.2 | 40 | 17 |
| 15.2 | 40 | 18 |
| 15.9 | 40 | 21 |
| 16.0 | 40 | 23 |
| 16.1 | 40 | 25 |
| 59.4 | 70 | 1 |
| 55.4 | 70 | 2 |
| 47.4 | 70 | 3 |
| 41.6 | 70 | 4 |
| 18.8 | 70 | 7 |
| 15.8 | 70 | 8 |
| 12.0 | 70 | 10 |
| 9.2 | 70 | 16 |
| 8.9 | 70 | 17 |
| 8.4 | 70 | 18 |
| 7.8 | 70 | 21 |
| 7.8 | 70 | 23 |
| 7.2 | 70 | 25 |

1. A method for delivering antimicrobial compounds to a locus in a controlled manner;
said method comprising adding to the locus a compound having formula (I) 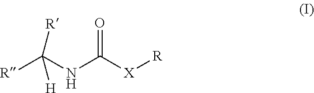
wherein X is O or NH; R is an acrylic polymer, a saturated polyester, an alkyd resin, a polyether or a polycarbonate and R optionally has additional XC(O)NHCHR′R″ substituents;
R′ is hydroxyl or NHC(O)XR; and R″ is an organic substituent group having from one to twenty carbon atoms and which optionally has additional CHR′NHC(O)XR substituents.

2. The method of claim 1 in which R″ is a difunctional substituent which is attached to another CHR′NHC(O)XR moiety.

3. The method of claim 2 in which R has additional XC(O)NHCHR′R″ substituents.

4. The method of claim 3 in which R″ is a C₅-C₂₀ aromatic group, a C₂-C₁₅ difunctional alkyl group or a C₆-C₁₅ difunctional cycloalkyl group.

5. The method of claim 4 in which has an average equivalent weight per XC(O)NHCHR′R″ group from 85 to 3,000.

6. A method for delivering antimicrobial compounds to a locus in a controlled manner; said method comprising adding to the locus a polymer comprising polymerized units of a polyaldehyde having from two to twenty carbon atoms and polymerized units of a compound having at least two —XC(O)NH₂ groups, wherein X is O or NH.

7. The method of claim 6 in which the polyaldehyde has from two to four aldehyde groups.

8. The method of claim 7 in which the compound having at least two —XC(O)NH₂ groups has an average equivalent weight per —XC(O)NH₂ group from 85 to 3,000.

9. The method of claim 8 in which the compound having at least two —XC(O)NH₂ groups has Mw from 100 to 4000.

10. The method of claim 9 in which the polymer in use is exposed to a temperature of at least 40° C.
